(19) United States
(12) Patent Application Publication
(10) Pub. No.: US 2017/0032481 A1
(43) Pub. Date: Feb. 2, 2017

(54) METHOD AND SYSTEM FOR IDENTIFYING A PROPERTY FOR PURCHASE AND RELATED PRODUCTS AND SERVICES USING IMAGE PROCESSING

(71) Applicant: THE TORONTO-DOMINION BANK, Toronto (CA)

(72) Inventors: ROY D'SOUZA, OAKVILLE (CA); NICOLA BROWNE, THORNHILL (CA); ROISIN LARA FRITZ, TORONTO (CA); JONATHAN K. BARNETT, OAKVILLE (CA); JOHN JONG SUK LEE, WATERLOO (CA); PAUL MON-WAH CHAN, MARKHAM (CA); ORIN DEL VECCHIO, RICHMOND HILL (CA)

(21) Appl. No.: 14/928,636

(22) Filed: Oct. 30, 2015

Related U.S. Application Data
(60) Provisional application No. 62/198,066, filed on Jul. 28, 2015.

(51) Int. Cl. G06Q 50/16; G06Q 30/06

(52) U.S. Cl. CPC G06Q 50/16; G06Q 30/0627; G06Q 30/0631

(57) ABSTRACT

A method for identifying a property for purchase by an image processing system, comprising: receiving one or more images from a user device, wherein the one or more images are images of properties with additional matter, wherein the user device captures and stores the one or more images, and wherein the additional matter is indicative of one or more of user demographic, lifestyle, and behaviour; identifying one or more property attributes and one or more contextual attributes within the one or more images, wherein the one or more property attributes provide information pertaining to the properties in isolation from the additional matter, and wherein the one or more contextual attributes provide information pertaining to the additional matter; generating image data, the image data including the one or more images, the one or more property attributes, and the one or more contextual attributes; extracting user preference information directly from the image data, the user preference information including one or more preferred aesthetic property attributes and one or more preferred contextual attributes; searching an available property database using the user preference information; receiving available property information from the available property database that matches the user preference information, the available property information including information relating to one or more properties that are available for purchase; and, presenting the available property information on a display.

This application claims priority from and the benefit of the filing date of U.S. Provisional Patent Application No. 62/198,066, filed Jul. 28, 2015, and the entire content of such application is incorporated herein by reference.

### FIELD OF THE APPLICATION

This application relates to the field of image and data processing, and more specifically, to a method and system for identifying a property for purchase and related products and services using image processing.

### BACKGROUND OF THE APPLICATION

Buying a home or other property is a complicated process for buyers. Looking over property listings requires much time and effort and is often overwhelming. Realtors may provide automated email lists based on very broad purchasing preferences (e.g., location, type of house, number of rooms, etc.) for their clients, buyers, or users. These automated email lists may include image data or links to image data for the listed properties. However, one problem with such email lists is that they are usually so broad that a user has to review dozens if not hundreds of property listings and images before finding a property that matches or satisfies their requirements. In addition, first time home or property buyers may not know what they truly require or prefer in a home or property. Furthermore, they may not know how to articulate or express their aesthetic preferences with respect to homes and properties. Still further, they may not be aware of related products and services that may be of assistance to them.

A need therefore exists for an improved method and system for identifying property attributes from image data that are appealing to a user to reduce the number of property listings and related product and service offerings that the user need review. Accordingly, a solution that addresses, at least in part, the above and other shortcomings is desired.

### SUMMARY OF THE APPLICATION

According to one aspect of the application, there is provided a method for identifying a property for purchase by an image processing system, comprising: receiving one or more images from a user device, wherein the one or more images are images of properties with additional matter, wherein the user device captures and stores the one or more images, and wherein the additional matter is indicative of one or more of user demographic, lifestyle, and behaviour; identifying one or more property attributes and one or more contextual attributes within the one or more images, wherein the one or more property attributes provide information pertaining to the properties in isolation from the additional matter, and wherein the one or more contextual attributes provide information pertaining to the additional matter; generating image data, the image data including the one or more images, the one or more property attributes, and the one or more contextual attributes; extracting user preference information directly from the image data, the user preference information including one or more preferred aesthetic property attributes and one or more preferred contextual attributes; searching an available property database using the user preference information; receiving available property information from the available property database that matches the user preference information, the available property information including information relating to one or more properties that are available for purchase; and, presenting the available property information on a display.

According to another aspect of the application, there is provided a method for identifying a product for purchase by an image processing system, comprising: receiving one or more images from a user device, wherein the one or more images are images of properties with additional matter, wherein the user device captures and stores the one or more images, and wherein the additional matter is indicative of one or more of user demographic, lifestyle, and behaviour; identifying one or more contextual attributes within the one or more images, wherein the one or more contextual attributes provide information pertaining to the additional matter; generating user insight information from the one or more contextual attributes; searching a third party component using the user insight information; receiving third party information from the third party component that matches the user insight information, the third party information including information relating to one or more products that are available for purchase; and, presenting the third party information on a display.

In accordance with further aspects of the application, there is provided an apparatus such as a data processing system, an image processing system, etc., a method for adapting same, as well as articles of manufacture such as a computer readable medium or product and computer program product or software product (e.g., comprising a non-transitory medium) having program instructions recorded thereon for practising the method of the application.

### BRIEF DESCRIPTION OF THE DRAWINGS

Further features and advantages of the embodiments of the present application will become apparent from the following detailed description, taken in combination with the appended drawings, in which:

FIG. 1 is a block diagram illustrating a data processing system in accordance with an embodiment of the application;

FIG. 2 is a block diagram illustrating a system for identifying a property for purchase by a user from image data in accordance with an embodiment of the application;

FIG. 3 is a flow chart illustrating operations of modules within a data processing system or systems for identifying a property for purchase by a user from image data, in accordance with an embodiment of the application; and,

FIG. 4 is a block diagram illustrating an image of a property in accordance with an embodiment of the application.

It will be noted that throughout the appended drawings, like features are identified by like reference numerals.

### DETAILED DESCRIPTION OF THE EXAMPLE EMBODIMENTS

In the following description, details are set forth to provide an understanding of the application. In some instances, certain software, circuits, structures and methods have not been described or shown in detail in order not to obscure the application. The terms “data processing system”, “image processing system”, etc. are used herein to refer to any machine for processing data, including the computer systems, wireless devices, and network arrangements described herein. The present application may be implemented in any computer programming language provided that the operating system of the data processing system provides the facilities that may support the requirements of the present application. Any limitations presented would be a result of a particular type of operating system or computer programming language and would not be a limitation of the present application. The present application may also be implemented in hardware or in a combination of hardware and software.

The present application provides a method and system for more precisely determining properties that may be acceptable to a potential buyer or user so as to narrow down the options presented to the user thus focusing the user's search. According to one embodiment of the application, a method and system is provided that analyzes a user's previously identified images (e.g., photographs, etc.), identifies the user's preferences and patterns, prioritizes the user's likes and dislikes, and thereby develops a more precise home buying profile by analyzing the images. The images are received from and are associated with the user. The images may be received from the user's postings to social media platforms (e.g., Houzz™, Pinterest™, Instagram™, Facebook™, Google™ Photos, etc.), the user's digital camera, the user's scanned photographs, the user's drop boxes, the user's cloud collections, and other of the user's storage devices for personal images. For example, the method and system may deduce that a user's primary priority is a house having large windows to let in lots of sunlight. The method and system would then recommend houses having a number of large windows. Likewise, the method and system may deduce that the user has children, a pet dog, and enjoys the outdoors. As such, the method and system would then recommend properties having a large yard space and/or proximity to public parks. Advantageously, the method and system of the present application help home buyers or users find their “dream” home, simplifies the home search process, and makes that search process more enjoyable for them. In addition, the present application allows service providers (e.g., realtors, real estate agents, banks, mortgage brokers, etc.) to engage with potential buyers earlier in the process, improve loyalty between users and service providers, and improve service.

According to one embodiment, the user's image data is analyzed to identify “aesthetic” property features or attributes such as exterior siding, doors, balconies, floors, color, island kitchens, etc. These aesthetic property attributes are in contrast to the “functional” property features or attributes such as number of bedrooms, number of bathrooms, number of floors, square footage, etc., that are typically included in available property databases (e.g., MLS™ listings, Google™ Street View, etc.). Thus, as used herein, aesthetic property attributes pertain to the “look” of a house while functional property attributes pertain to the “specifications” of the house. The use of aesthetic property attributes allows for houses having the same or similar functional property attributes to be distinguished.

According to one embodiment, the aesthetic property attributes may be divided or categorized into permanent aesthetic property attributes and temporary aesthetic property attributes. Permanent aesthetic property attributes include attributes that cannot be easily modified such as exterior siding, balcony placement, etc. Temporary aesthetic property attributes include attributes that can be easily modified such as paint colour, floor covering, etc. If a particular house includes the permanent aesthetic property attributes that a user prefers but the interior walls are not painted the preferred colour (i.e., a temporary aesthetic property attribute), the house may still be recommended as the interior walls may be repainted (at a given cost).

For reference, computer vision refers to methods and systems for acquiring, processing, analyzing, and understanding images of real world objects and scenes in order to produce numerical or symbolic information, e.g., in the forms of decisions. Many computer vision systems attempt to duplicate the abilities of human vision by electronically perceiving and understanding image data using models constructed with the aid of geometry, physics, statistics, and learning theory. The image data can take many forms, such as digital camera images, video sequences, or views from multiple cameras or scanners.

Recognition is one application of computer vision. The basic goal of computer vision in this regard is to determine whether or not image data contains a specific object, feature, or activity. In image or object recognition (also called object classification) methods and systems, one or several pre-specified or learned objects or object classes are recognized, usually together with their two-dimensional (“2D”) positions in an image or three-dimensional (“3D”) poses in a scene. In object identification methods and systems, an individual instance of an object is recognized. Examples include identification of a specific person's face or fingerprint, identification of handwritten digits, or identification of a specific vehicle. In object detection methods and system, the image data is scanned for a specific condition. Examples include detection of defects in manufacturing processes or detection of a vehicle in an automatic road toll system.

Several tasks may be performed using recognition techniques. In content-based image retrieval (“CBIR”) methods and systems, all images in a larger set of images which have a specific content are found. The content may be specified in different ways, for example, in terms of similarity relative to a target image (e.g., find all images similar to image X), or in terms of high-level search criteria given as text input (e.g., find all images which contains many houses, are taken during winter, and have no cars in them). In pose estimation methods and systems, the position or orientation of a specific object relative to the camera is estimated. An example application of this technique would be assisting a robot arm in retrieving objects from a conveyor belt in an assembly line situation or picking parts from a bin. In optical character recognition (“OCR”) methods and systems, characters in images of printed or handwritten text are identified, usually with a view to encoding the text in a format more amenable to editing or indexing.

Recognition techniques may be used to detect features of homes such as columns, double doors, decorative windows, etc. In addition, these techniques may be used to identify specific instances of a feature (e.g., double doors) and whether that feature is duplicated.

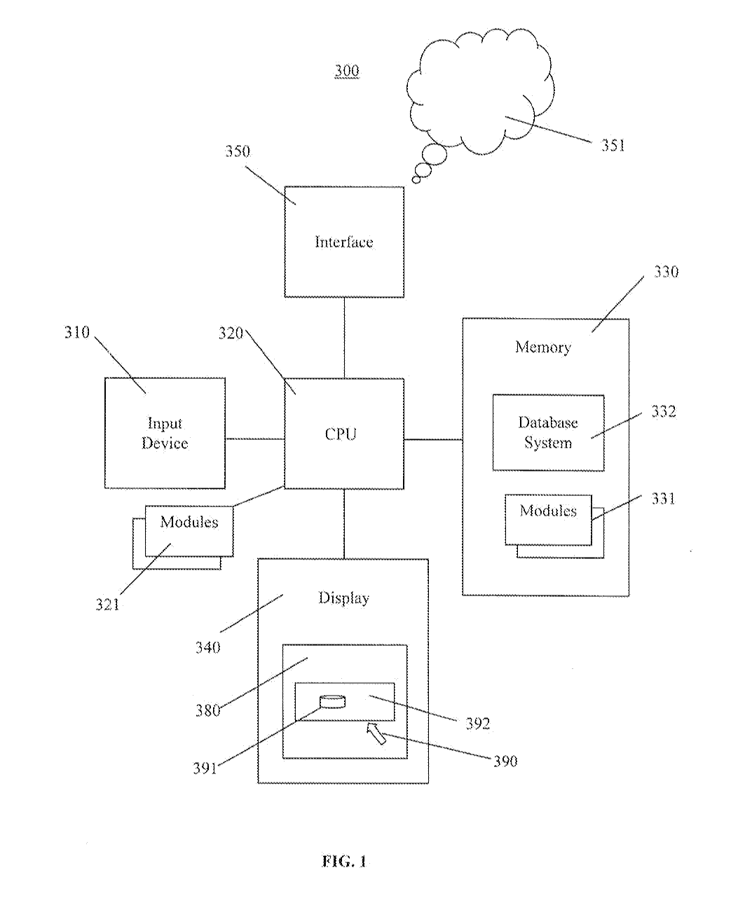

FIG. 1 is a block diagram illustrating a data processing system 300 in accordance with an embodiment of the invention. The data processing system 300 is suitable for image and data processing, management, storage, and for generating, displaying, and adjusting presentations in conjunction with a user interface or a graphical user interface (“GUI”), as described below. The data processing system 300 may be or include an image processing system. The data processing system 300 may be a client and/or server in a client/server system (e.g., 100). For example, the data processing system 300 may be a server system or a personal computer (“PC”) system. The data processing system 300 may also be a mobile device or other wireless, portable, or handheld device. The data processing system 300 may also be a distributed system which is deployed across multiple processors. The data processing system 300 may also be a virtual machine. The data processing system 300 includes an input device 310, at least one central processing unit (“CPU”) 320, memory 330, a display 340, and an interface device 350. The input device 310 may include a keyboard, a mouse, a trackball, a touch sensitive surface or screen, a position tracking device, an eye tracking device, a camera, a tactile glove or gloves, a gesture control armband, or a similar device. The display 340 may include a computer screen, a television screen, a display screen, a terminal device, a touch sensitive display surface or screen, a hardcopy producing output device such as a printer or plotter, a head-mounted display, virtual reality (“VR”) glasses, an augmented reality (“AR”) display, a hologram display, or a similar device. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). As such, the interface 350 may include suitable transmitters, receivers, antennae, etc. In addition, the data processing system 300 may include a Global Positioning System (“GPS”) receiver. Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands, queries, or data and to the display 340 for displaying the results of these commands, queries, or data to the user. Commands, queries, and data may also be received via the interface device 350 and results and data may be transmitted via the interface device 350. The data processing system 300 may include a data store or database system 332 for storing data and programming information. The database system 332 may include a database management system (e.g., 332) and a database (e.g., 332) and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the application.

Thus, the data processing system 300 includes computer executable programmed instructions for directing the system 300 to implement the embodiments of the present application. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium or product (e.g., one or more digital video disks (“DVDs”), compact disks (“CDs”), memory sticks, etc.) which may be used for transporting the programmed instructions to the memory 330 of the data processing system 300. Alternatively, the programmed instructions may be embedded in a computer-readable signal or signal-bearing medium or product that is uploaded to a network 351 by a vendor or supplier of the programmed instructions, and this signal or signal-bearing medium or product may be downloaded through an interface (e.g., 350) to the data processing system 300 from the network 351 by end users or potential buyers.

A user may interact with the data processing system 300 and its hardware and software modules 321, 331 using a user interface such as a graphical user interface (“GUI”) 380 (and related modules 321, 331). The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input device 310 such as a mouse. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse) 310 to position a pointer or cursor 390 over an object (e.g., an icon) 391 and by selecting or “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

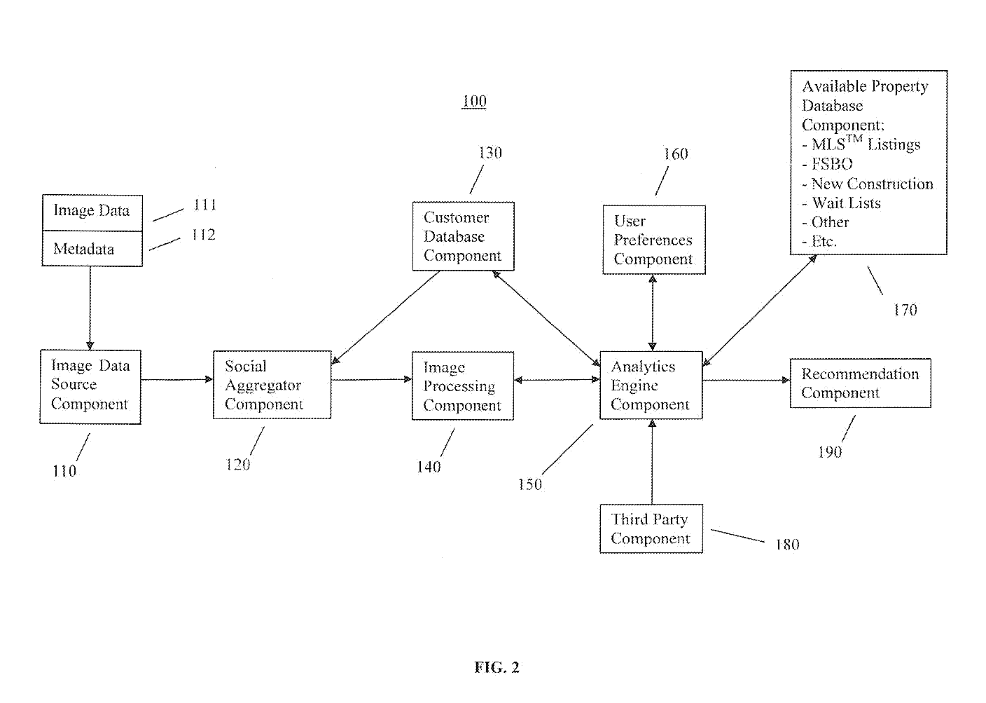

FIG. 2 is a block diagram illustrating a system 100 for identifying a property for purchase by a user from image data in accordance with an embodiment of the application. The system 100 may be implemented within the data processing system 300 of FIG. 1 using software modules 331 and/or hardware modules 321. The system 100 includes an image data source component 110, a social aggregator component 120, a customer database component 130, an image processing component 140, an analytics engine component 150, a user preferences component 160, an available property database (e.g., a Multiple Listing Service™ (“MLS™”) database, etc.) component 170, a third party component (or available product/service database) 180, and a recommendation component 190.

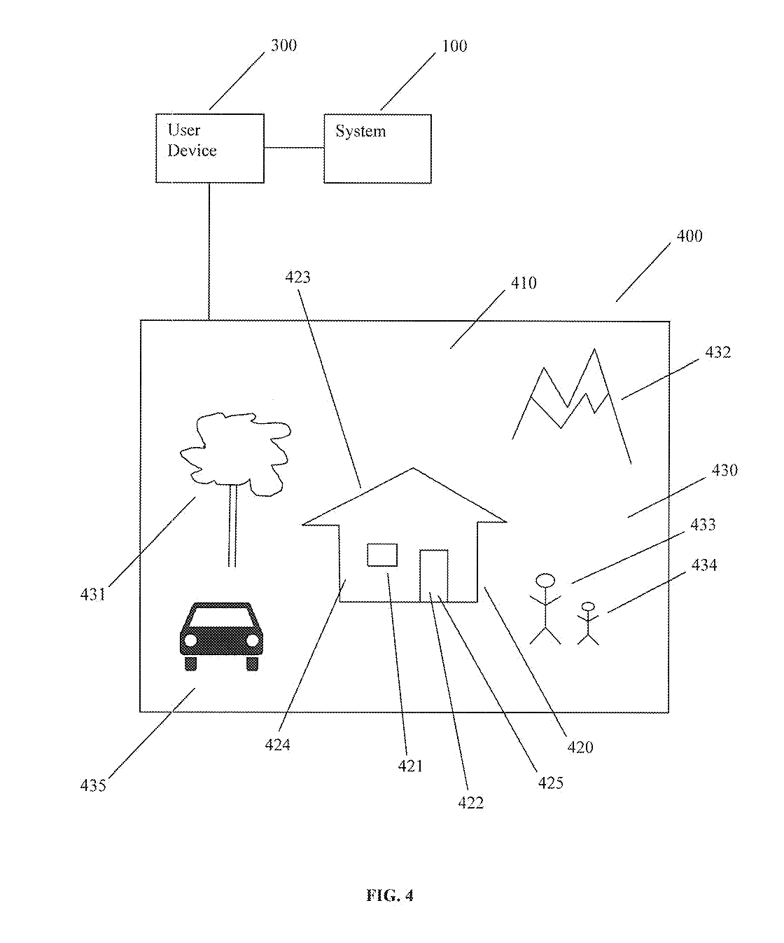

FIG. 4 is a block diagram illustrating an image 400 of a property 410 in accordance with an embodiment of the application. In FIG. 4, the property 410 is or includes a house 420. The house 420 has a window 421, a door 422, and a gable roof 423. These features may be identified in the image 400 and stored as property attributes (e.g., image data) by the system 100. While the example image 400 of FIG. 4 shows mainly features on the exterior 424 of the house 420, the image 400 may also show features in the interior 425 of the house 420. In addition to the house 420, the image 400 includes other or additional matter 430. The additional matter 430 may provide context for the house 420 in the image 400. The additional matter 430 may include features or items surrounding, within, adjacent to, or superimposed on the house 420. In FIG. 4, the other matter 430 includes a tree 431, a mountain 432, an adult person 433, a child 434, and an automobile 435. These features or items may be identified in the image 400 and stored as contextual attributes (e.g., image data) by the system 100. As such, the additional matter 430 may be indicative of a user's demographic, lifestyle, and/or behaviour. Subsequently, the user's image data may be analyzed to identify preferred contextual attributes such as surrounding trees, mountains, etc.

The image data source component 110 receives image data 111 from a user device or system 300. The user device or system 300 may have a configuration similar to the data processing system 300 of FIG. 1. The image data 111 maybe uploaded to the system 100 using an online application hosted by the system 100, for example. The image data 111 may originate from various social media applications used by the user such as Houzz™, Pinterest™, Instagram™, and Facebook™. Alternatively, the image data 111 may originate from a camera 310 included or associated with the user device or system 300. As another alternative, the image data 111 may original from a public image database from which contextual information may be derived. The image data 111 may include one or more images (e.g., 400) which may include digital images, photographs, digital photographs, sequences of images, analog video, digital video, video clips, movies, movie clips, etc. The image data 11 may include tags or metadata 112 which may provide information associated with the user or the user's device, the image, the location where the image was captured, the time and data when the image was captured, etc. For example, the image data 111 may be geo-tagged using a GPS system associated with the user device or system 300 as described above. The image data source component 110 may preprocess the image data 111 by adding information (e.g., user preference information) related to the image data 111 received from a user via an online questionnaire, form, or input screen presented to the user via the display 340 of the user's device 300, for example, at the time the user uploads the original image data 111 to the system 100. In general, the subject matter of the one or more images included in the image data 111 pertains to a property, home, house, condo, apartment, etc., or attributes thereof, that the user is interested in purchasing, leasing, or renting.

The social aggregator component 120 receives the image data 111 from the image data source component 110. The social aggregator component 120 collects and aggregates the image data 111 for the user. It applies rules for collecting the image data 111 and for associating information with the image data 111. For example, the social aggregator component 120 and/or the image processing component 140 (see below) may assign a higher weighting to image data 111 received from Facebook™ that has been “posted” by the user and a lower weighting to image data 111 that has been merely “liked” by the user.

The social aggregator component 120 is coupled to a customer database component 130 which stores user information relating to the user such as the user's various banking or other account information, financial information, address information, age information, demographic information, credit score (i.e., what the user can afford), etc. The financial information may include the financial products that the user presently has, the credit available to the user for the purchase of a property, and the cash flow available from the user for the payments of any mortgage or rental fees associated with the purchase or rental of a property. The social aggregator component 130 may associate selected user information from the customer database component 130 for the user with the image data 111. The customer database component 130 may be associated with and/or maintained by the user's financial institution, for example, the user's bank.

The image processing component 140 receives the image data 111 and associated information from the social aggregator component 130. The image processing component 140 analyzes the image data 111 received and may add or modify the information associated therewith with a view to improving the performance of subsequent processing. For example, the image processing component 140 may compare the various images in the image data 111 to determine what is similar between the images. For example, the various images (e.g., 400) may each show a house (e.g., 420) with a gable roof (e.g., 423). This information may be associated with the image data 111. As another example, the image processing component 140 may compare the various images in the image data 111 to determine whether any images do not belong. For example, 10 images of the various images may show a house with a gable roof and one image may show an iceberg. This information may be associated with the image data 111 and the iceberg image may be tagged or weighted accordingly.

The image processing component 140 analyzes the image data 111 to infer the user's preferences with respect to houses or their attributes. The user's image data is analyzed to identify preferred aesthetic property attributes such as exterior siding, doors, balconies, floors, color, island kitchens, etc. These aesthetic property attributes are in contrast to the functional property attributes such as number of bedrooms, number of bathrooms, number of floors, square footage, etc., that are typically included in available property databases (e.g., MLS™ listings, etc.). The use of preferred aesthetic property attributes allows for houses having the same or similar functional property attributes to be distinguished. The aesthetic property attributes may be divided or categorized into permanent aesthetic property attributes and temporary aesthetic property attributes. Permanent aesthetic property attributes include attributes that cannot be easily modified such as exterior siding, balcony placement, etc. Temporary aesthetic property attributes include attributes that can be easily modified such as paint colour, floor covering, etc. If a particular house includes the permanent aesthetic property attributes that a user prefers but the interior walls are not painted the preferred colour (i.e., a temporary aesthetic property attribute), the house may still be recommended as the interior walls may be repainted (at a given cost). The user's preferences with respect to houses or their attributes may be inferred from these aesthetic property attributes.

For example, if the image data 111 includes 20 images of houses with gable roofs and only 2 images of houses with flat roofs, then the image processing component 140 may infer that the user has a preference for houses with gable roofs. As a further example, if the image data 111 includes images of school age children (e.g., 434), then the image processing component 140 may infer that the user has a preference for houses located on other than main roads or busy streets. As a further example, if the image data 11 includes several images of houses with double doors, then the image processing component 140 may infer that the user has a preference for houses with double doors. As a further example, if the image data 111 includes several images of doors located in specific places, doors of a specific size, doors of a specific style, etc., then the image processing component 140 may infer that the user has preferences for houses having doors located in those specific places, doors having that specific size, doors having that specific style, etc. As a further example, if the image data 111 includes images of various schools, educational facilities, etc., then the image processing component 140 may infer that the user has a preference for houses located within a particular school district or zone. As a further example, if the image data 111 includes images of various store fronts, signage, buildings of a specific type, style or age, restaurants serving foods of a specific type or style, stores selling products of a specific type or style, etc., indicative of a neighbourhood type, then the image processing component 140 may infer that the user has a preference for houses located within a neighbourhood of that type. This inferred user preference information may be associated with the image data 111. In addition, this inferred user preference information may be used in assigning weightings to the various images in the image data 111 or to the various preferred aesthetic property attributes.

The image processing component 140 may review date information for the various images in the image data 111 to determine whether any images are of such an age (e.g., when compared to a predetermined image age threshold) that they should be assigned a lower weighting. For example, fifteen images of the various images may have been captured in 2015 while two images of the various images may have been captured in 2010. This information may be added to the metadata 112 for the image data 111 and the two images from 2010 may be tagged accordingly. That is, the images captured in 2010 may be assigned a lower weighting than the images captured in 2015.

As will be discussed further below, the image processing component 140 may also receive user preference information outlining the user's preferences with respect to houses or their attributes from a user preferences component 160. The user preference information may also include the user's preferences with respect to outdoor activities, lifestyle, location (e.g., urban, suburban, rural, etc.), etc. The user preferences component 160 may receive the user preference information from the user via an online questionnaire, form, or screen presented to the user via the display 340 of the user's device 300, for example, at the time the user uploads the original image data 111 to the system 100 or subsequently. This user preference information may include attributes such as the number of bedrooms desired (e.g., 2, 3, 4, etc.), the number of bathrooms desired (e.g., 1, 2, 3, etc.), the type of roof desired (e.g., gable, flat, etc.), the size of backyard desired (e.g., small, large, etc.), the location of the house desired (e.g., region of a city, proximity to schools, proximity to playgrounds, etc.), etc. This user preference information may be associated with the image data 111.

According to one embodiment, the user preference information may also include weighting information (or weights) indicating the importance of various attributes of the user preference information to the user. This weighting information may be generated by the image processing component 140 and/or received from the user with the user preference information. For example, the user may assign a weight of 4 (out of 5) to a gable roof. After analysis of the image data 111, the image processing component 140 may retain that weight (i.e., 4 out of 5) or possibly increase (e.g., 4.5 out of 5) or decrease that weight (e.g., 3 out of 5) depending on the additional information included in the image processing component's analysis.

According to one embodiment, the weighting information may be automatically generated by the image processing component 140 based on user preference information and the recurrence or repetition of images relating to various attributes in the image data 111. For example, if the image data 111 includes 30 images showing a gable roof and 5 images showing a flat roof and the user preference information indicates that the user prefers a gable roof, then the image processing component 140 may assign a weight of 4 (out of 5) to the gable roof attribute and a weight of zero or 1 (out of 5) to the flat roof attribute. As another example, if the user preference information indicates that the user's objective is to purchase a property for a specific purpose (e.g., primary residence, investment, cottage use, commercial use, etc.), then the image processing component 140 may assign a higher weight to attributes associated with that objective and a lower weight to attributes that are not associated with that objective.

According to one embodiment, the user preference information may be received from a user via a graphical user interface 380 through which the user may review the image data 111. Upon viewing various of the images in the image data 111, the user may “like” an image (or an attribute shown in the image) by swiping right on the image and may pass or reject an image (or an attribute shown in the image) by swiping left on the image (or vise versa). Images that are “liked” by the user may be assigned a higher weight than images that are not “liked” by the user. For example, the user may swipe right on images of houses having gable roofs. As such, those images (or attributes shown in those images) may be assigned a weight of 4 (out of 5). Similarly, the user may swipe left on images of houses having flat roofs. As such, those images (or attributes shown in those images) may be assigned a weight of zero or 1 (out of 5).

The analytics engine component 150 is coupled to the image processing component 140, receives image data 111 and associated information (e.g., user preference information, etc.) from the image processing component 140, and provides feedback to the image processing component 140 as will be discussed further below. In addition, the analytics engine component 150 receives user preference information from the user preference component 160 (described above), available property information from an available property database component 170, third party information (or available product/service information) from a third party component (or available product/service database) 180, and user information from the customer database component 130 (described above). The analytics engine component 150 generates a preferred home profile from one or more of the user preference information, the user information, the image data 111, and the metadata 112.

In response to a query constructed by the analytic engine component 150 from the preferred home profile, the available property database component 170 makes available to the analytics engine 150 available property information including images and other data relating to one or more properties that may be of interest to the user. The available property database may include MLS™ listings, for sale by owner (“FSBO”) listings, new construction listings, and “watch lists”. The watch lists may include houses or properties that are not yet for sale but may still be of interest to the user.

The third party component 180 makes available to the analytics engine 150 third party information relating to products, services, contractors for home renovation projects, home inspectors, local restaurants, local entertainment, government regulations or programs, and other financial and non-financial information. For example, if the image data 111 includes images of certain foods, the third party information may include a listing of local restaurants which serve those foods.

The analytics engine component 150 analyzes the preferred home profile, the available property information, and/or the third party information and generates one or more insights (or user insight information) with respect to the user and one or more recommendations with respect to a property that may satisfy the user's preferences and desires (i.e., as expressed or inferred). For example, the analytics engine component 150 may determine whether the user's preferences are aspiratory or realistic, whether the user is interested in a cottage or second home property, whether the user is interested in investment properties, what life stage the user is at, what life changes the user has experienced, etc., and generate insights accordingly. These insights and recommendations may be fed back to the image processing component 140 for association with the image data 111 making future use of this information more efficient. For example, the insights may be used by the image processing component 140 to adjust the weights applied to various attributes of the user preference information.

In addition, these insights and recommendations may be output to the customer database 130 for use by other systems. For example, if there are a number of images of babies (e.g., 434) in the image data 111 and life stage of the user inferred indicates that the user is in the child rearing stage, then the user may be offered a registered educations saving plan (“RESP”) product selected from the third party component 180. Other factors may be taken into consideration as well. For example, if it is known that the user is in the home daycare business or other business related to children, then an offer of a RESP product selected from the third party component 180 may be qualified accordingly. As another example, if there are a number of images of automobiles (e.g., 435) in the image data 111, then the user may be offered an automobile loan product selected from the third party component 180. In addition, if the life stage of the user inferred indicates that the user is in the child rearing stage, then the automobile load product may be tailored to the purchase or lease of a family automobile such as a minivan.

Furthermore, if the analytics engine component 150 determines that the user preference information or the insights or recommendations that is has generated are of low confidence, revised, new, or improved user preference information or image data 111 may be requested from the user and new insights and recommendations may be generated therefrom.

The recommendation component 190 receives the one or more recommendations from the analytics engine component 150 and presents the one or more recommendations to the user via the display 340 of the user's device 300, for example. As mentioned above, the recommendations may include a recommendation to purchase a particular property. In addition, the recommendations may include a recommendation to renovate a particular property rather than simply purchasing that property. This may be the case if the properties available do not include all of the preferred aesthetic property attributes included in the user preference information or preferred home profile.

According to one embodiment, the user may validate recommendations made by the analytics engine component 150 and recommendation component 190 via a graphical user interface 380 through which the user may review the recommendations and images relating to the recommendations. Upon viewing various of the images relating to a recommendation, the user may “like” an image or recommendation by swiping right on the image or recommendation and may pass or reject an image or recommendation by swiping left on the image or recommendation (or vise versa). For feedback purposes, images or recommendations that are “liked” by the user may be assigned a higher weight than images or recommendations that are not “liked” by the user.

According to one embodiment, there is provided a method for identifying a property for purchase by an image processing system 100, comprising: receiving one or more images 400 from a user device (e.g., 300), wherein the one or more images 400 are images of properties with additional matter, wherein the user device 300 captures and stores the one or more images 400, and wherein the additional matter is indicative of one or more of user demographic, lifestyle, and behaviour; identifying one or more property attributes and one or more contextual attributes within the one or more images 400, wherein the one or more property attributes provide information pertaining to the properties in isolation from the additional matter, and wherein the one or more contextual attributes provide information pertaining to the additional matter; generating image data 111, the image data 111 including the one or more images 400, the one or more property attributes, and the one or more contextual attributes; extracting user preference information directly from the image data 111, the user preference information including one or more preferred aesthetic property attributes and one or more preferred contextual attributes; searching an available property database 170 using the user preference information; receiving available property information from the available property database 170 that matches the user preference information, the available property information including information relating to one or more properties that are available for purchase; and, presenting the available property information on a display 340.

According to another embodiment, there is provided a method for identifying a product (or service) for purchase (or use) by an image processing system 100, comprising: receiving one or more images 400 from a user device 300, wherein the one or more images 400 are images of properties with additional matter, wherein the user device 300 captures and stores the one or more images 400, and wherein the additional matter is indicative of one or more of user demographic, lifestyle, and behaviour; identifying one or more contextual attributes within the one or more images 400, wherein the one or more contextual attributes provide information pertaining to the additional matter; generating user insight information from the one or more contextual attributes; searching a third party component 180 using the user insight information; receiving third party information from the third party component 180 that matches the user insight information, the third party information including information relating to one or more products (or services) that are available for purchase (or use); and, presenting the third party information on a display 340.

According to further embodiment, there is provided a method for determining a potential home for purchase by a user, comprising: collecting user image data 111, the user image data including images which reference housing in the image, in any associated text, and/or in any metadata 112 associated with the image; analyzing the user image data 11 against a list of weighted home attributes, the home attributes including one or more of price, location, size, type, amenities, and aesthetics; retrieving one or more sample images associated with each home attribute; sending the user two sample images, each associated with a different home attribute, and requesting an indication of user preference; receiving the indication of user preference and adjusting the weighting of the home attributes accordingly; generating a recommended home profile containing the weighted home attributes; searching a home availability database (e.g., a MLS database 170) for an available home matching the recommended home profile; and, sending information pertaining to the available home to the user.

Aspects of the above described methods and systems may be summarized with the aid of a flowchart.

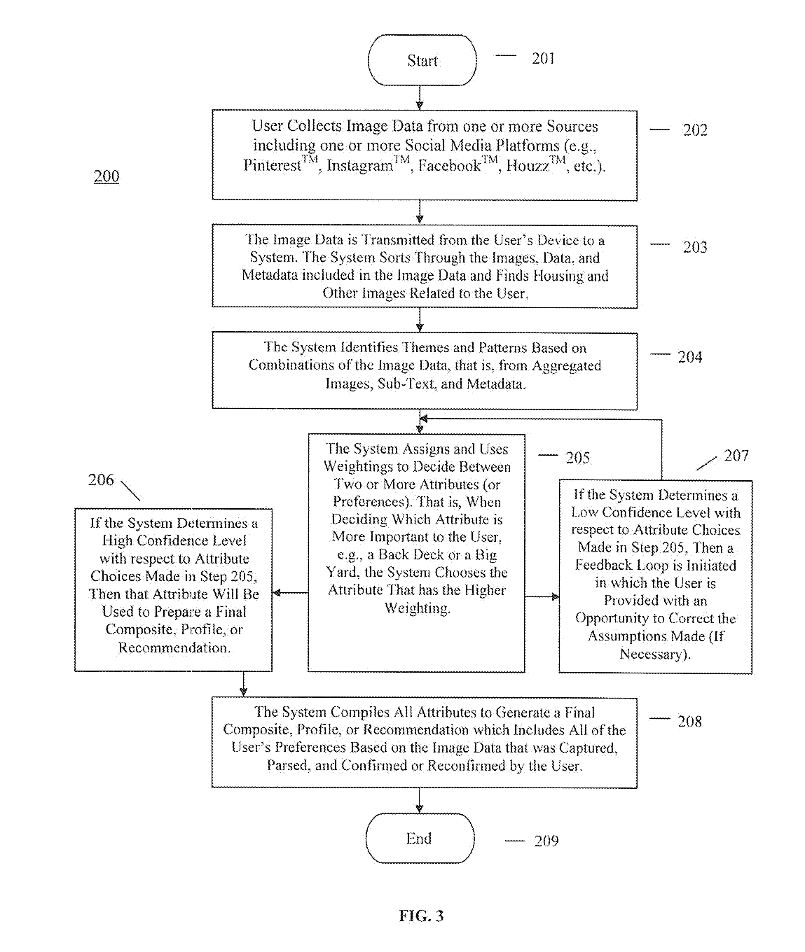

FIG. 3 is a flow chart illustrating operations 200 of modules (e.g., 331) within a data processing system or systems (e.g., 100, 300) for identifying a property for purchase by a user from image data 111, in accordance with an embodiment of the application.

At step 201, the operations 200 start.

At step 202, a user collects image data 111 from one or more sources including one or more social media platforms (e.g., Pinterest™, Instagram™, Facebook™, Houzz™, etc.). The images may be collected using the user's device 300.

At step 203, the image data 111 is transmitted from the user's device 300 to a system 100. The system 100 sorts through the images, data, and metadata included in the image data 111 and finds housing and other images related to the user (i.e., regardless of the user's intention to purchase). The system 100 may be implemented by a central data processing system or server 300 coupled to the user's device 300 over a network 351.

At step 204, the system 100 identifies themes and patterns based on combinations of the image data 111, that is, from aggregated images, sub-text, and metadata 112.

At step 205, the system 100 assigns and uses weightings to decide between two or more attributes (or preferences). That is, when deciding which attribute is more important to the user, e.g., a back deck or a big yard, the system 100 chooses the attribute has the higher weighting.

At step 206, if the system 100 determines a high confidence level with respect to the attribute choices made in step 205, then that attribute will be used to prepare a final composite, profile, or recommendation.

At step 207, if the system 100 determines a low confidence level with respect to the attribute choices made in step 205, then a feedback loop is initiated in which the user is provided with an opportunity to correct the assumptions made (if necessary).

At step 208, the system 100 compiles all attributes to generate a final composite, profile, or recommendation which includes all of the user's preferences based on the image data that was captured, parsed, and confirmed or reconfirmed by the user.

At step 209, the operations 200 end.

According to one embodiment, each of the above steps 201-209 may be implemented by a respective software module 331. According to another embodiment, each of the above steps 201-209 may be implemented by a respective hardware module 321. According to another embodiment, each of the above steps 201-209 may be implemented by a combination of software 331 and hardware modules 321. For example, FIG. 3 may represent a block diagram illustrating the interconnection of specific hardware modules 201-209 (collectively 321) within the data processing system or systems 300, each hardware module 201-209 adapted or configured to implement a respective step of the method of the application.

While this application is primarily discussed as a method, a person of ordinary skill in the art will understand that the apparatus discussed above with reference to a data processing system 300 may be programmed to enable the practice of the method of the application. Moreover, an article of manufacture for use with a data processing system 300, such as a pre-recorded storage device or other similar computer readable medium or computer program product including program instructions recorded thereon, may direct the data processing system 300 to facilitate the practice of the method of the application. It is understood that such apparatus, products, and articles of manufacture also come within the scope of the application.

In particular, the sequences of instructions which when executed cause the method described herein to be performed by the data processing system 300 may be contained in a data carrier product according to one embodiment of the application. This data carrier product may be loaded into and run by the data processing system 300. In addition, the sequences of instructions which when executed cause the method described herein to be performed by the data processing system 300 may be contained in a computer software product or computer program product (e.g., comprising a non-transitory medium) according to one embodiment of the application. This computer software product or computer program product may be loaded into and run by the data processing system 300. Moreover, the sequences of instructions which when executed cause the method described herein to be performed by the data processing system 300 may be contained in an integrated circuit product (e.g., a hardware module or modules 321) which may include a coprocessor or memory according to one embodiment of the application. This integrated circuit product may be installed in the data processing system 300.

The embodiments of the application described above are intended to be examples only. Those skilled in the art will understand that various modifications of detail may be made to these embodiments, all of which come within the scope of the application.

What is claimed is:

1. A method for identifying a property for purchase by an image processing system, comprising:
receiving one or more images from a user device, wherein the one or more images are images of properties with additional matter, wherein the user device captures and stores the one or more images, and wherein the additional matter is indicative of one or more of user demographic, lifestyle, and behaviour;
identifying one or more property attributes and one or more contextual attributes within the one or more images, wherein the one or more property attributes provide information pertaining to the properties in isolation from the additional matter, and wherein the one or more contextual attributes provide information pertaining to the additional matter;
generating image data, the image data including the one or more images, the one or more property attributes, and the one or more contextual attributes;
extracting user preference information directly from the image data, the user preference information including one or more preferred aesthetic property attributes and one or more preferred contextual attributes;
searching an available property database using the user preference information;
receiving available property information from the available property database that matches the user preference information, the available property information including information relating to one or more properties that are available for purchase; and,
presenting the available property information on a display.

2. The method of claim 1, further comprising: receiving user information from a customer database, the user information including information relating to a user; searching the available property database using the user preference information and the user information; and, receiving available property information from the available property data that matches the user preference information and the user information.

3. The method of claim 2, further comprising selecting a recommended property from the available property information and presenting information pertaining to the recommended property on the display.

4. The method of claim 2, wherein the user information includes financial information pertaining to the user.

5. The method of claim 4, wherein the financial information includes one or more of funds available for down payment, funds available for monthly payments, funds available for renovation, cash flow, and income.

6. The method of claim 1, wherein the user preference information includes one or more preferred functional property attributes.

7. The method of claim 6, wherein the preferred functional property attributes include one or more of price, location, closing date, number of bedrooms, number of bathrooms, number of floors, square footage, size of lot, proximity to transit, proximity to schooling, and proximity to recreational activities.

8. The method of claim 1, wherein the user preference information includes a respective weighting for each preferred aesthetic property attribute and each preferred contextual attribute.

9. The method of claim 8, further comprising determining the respective weighting for each preferred aesthetic property attribute and each preferred contextual attribute from the image data.

10. The method of claim 8, further comprising determining the respective weighting for each preferred aesthetic property attribute and each preferred contextual attribute from the user information.

11. The method of claim 8, further comprising receiving the respective weighting for each preferred aesthetic property attribute and each preferred contextual attribute from the user device.

12. The method of claim 1, further comprising receiving confirmation of the user preference information from the user device.

13. The method of claim 1, wherein the property is one or more of a house, a vacation property, a rental property, a farm, and a condominium.

14. The method of claim 1, wherein the images of properties are images of interiors and exteriors of properties.

15. The method of claim 1, wherein the one or more images are one or more video clips.

16. An image processing system for identifying a property for purchase, comprising:
a processor coupled to memory and a display; and,
at least one of hardware and software modules within the memory and controlled or executed by the processor, the modules including:
a module for receiving one or more images from a user device, wherein the one or more images are images of properties with additional matter, wherein the user device captures and stores the one or more images, and wherein the additional matter is indicative of one or more of user demographic, lifestyle, and behaviour;
a module for identifying one or more property attributes and one or more contextual attributes within the one or more images, wherein the one or more property attributes provide information pertaining to the properties in isolation from the additional matter, and wherein the one or more contextual attributes provide information pertaining to the additional matter;
a module for generating image data, the image data including the one or more images, the one or more property attributes, and the one or more contextual attributes;
a module for extracting user preference information directly from the image data, the user preference information including one or more preferred aesthetic property attributes and one or more preferred contextual attributes;
a module for searching an available property database using the user preference information;
a module for receiving available property information from the available property database that matches the user preference information, the available property information including information relating to one or more properties that are available for purchase; and,
a module for presenting the available property information on a display.

17. A device for identifying a property for purchase, comprising:
a processor coupled to memory and a display; and,
at least one of hardware and software modules within the memory and controlled or executed by the processor, the modules including:
a module for receiving one or more images, wherein the one or more images are images of properties with additional matter, wherein the device captures and stores the one or more images, and wherein the additional matter is indicative of one or more of user demographic, lifestyle, and behaviour;
a module for identifying one or more property attributes and one or more contextual attributes within the one or more images, wherein the one or more property attributes provide information pertaining to the properties in isolation from the additional matter, and wherein the one or more contextual attributes provide information pertaining to the additional matter;
a module for generating image data, the image data including the one or more images, the one or more property attributes, and the one or more contextual attributes;
a module for extracting user preference information directly from the image data, the user preference information including one or more preferred aesthetic property attributes and one or more preferred contextual attributes;
a module for searching an available property database using the user preference information;
a module for receiving available property information from the available property database that matches the user preference information, the available property information including information relating to one or more properties that are available for purchase; and,
a module for presenting the available property information on a display.

18. A method for identifying a product for purchase by an image processing system, comprising:
receiving one or more images from a user device, wherein the one or more images are images of properties with additional matter, wherein the user device captures and stores the one or more images, and wherein the additional matter is indicative of one or more of user demographic, lifestyle, and behaviour;
identifying one or more contextual attributes within the one or more images, wherein the one or more contextual attributes provide information pertaining to the additional matter;
generating user insight information from the one or more contextual attributes;
searching a third party component using the user insight information;
receiving third party information from the third party component that matches the user insight information, the third party information including information relating to one or more products that are available for purchase; and,
presenting the third party information on a display.

19. The method of claim 18, wherein the product for purchase includes a service for purchase or use and wherein the one or more products available for purchase include one or more services available for purchase or use.

20. The method of claim 19, wherein one or more products are related to property financing or improvement.
